(19) United States
(12) Patent Application Publication
(10) Pub. No.: US 2006/0228111 A1
(43) Pub. Date: Oct. 12, 2006

(54) Wavelength-selective optical signal processing device

(76) Inventor: Steven Ian Pegg, Northamptonshire (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/566,924

(22) PCT Filed: Aug. 2, 2004
(86) PCT No.: PCT/EP04/51688

§ 371 Date: Feb. 1, 2006

(30) Foreign Application Priority Data
Aug. 2, 2003 (DE) 103 35 419.3

(51) Int. Cl. H04B 10/08

(52) U.S. Cl. 398/30

(57) ABSTRACT

In a wavelength-selective optical signal processing device, an outcoupling filter for decomposing an incoming wavelength multiplex comprising a plurality of channels at different wavelengths into a first and a second group of channels and an incoupling filter for combining the first group after having passed through a processing unit and the second group into an outgoing wavelength multiplex are combined in a continuous wavelength-selective reflecting structure.

The present invention relates to a signal processing device for selectively carrying out a processing of specific channels of a wavelength multiplex signal formed of a plurality of channels at different wavelengths.

Such a wavelength multiplex is generally formed of a large number of information channels which convey payload information, and at least one optical supervisory channel which transports information required for controlling the information channels and the information conveyed thereon in the nodes of a transmission network.

The processing of information and supervisory channels in the various devices of an information transmission system varies strongly for different reasons. E.g., in a node of such a network, it may be necessary first to evaluate the information transmitted on the supervisory channel in order to know how the individual information signals of the multiplex are to be processed at this node.

Another possible reason for different treatment of supervisory and information channels can be their different wavelengths. E.g. from U.S. Pat. No. 6,411,407, an optical information transmission system with regenerating amplifiers is known, in which wavelengths outside a band of maximum gain of the regenerating amplifiers are assigned to the optical supervisory channels. When passing through a regenerating amplifier, the supervisory channels experience less gain than the information channels. If this happened several times consecutively, the optical power of the supervisory channels would decrease so much with respect to that of the information channels that the supervisory channel would cease to be operable. Therefore, processing the supervisory channel separately from the information channels is necessary in order to compensate this different gain. According to U.S. Pat. No. 6,411,407, this is done by electrically terminating the supervisory channel of an incoming multiplex and reproducing the optical supervisory channel at the output of the amplifier unit. To this end, the known amplifier unit comprises a pre-amplifier for each transmission direction, which is passed through by the complete incoming signal multiplex, a so-called SCW filter which separates the optical supervisory channel from the information channels and leads it to a supervisory module for termination, a second SCW filter which receives the information channels from the first SCW filter and the newly reproduced supervisory channel from the supervisory module and combines these into an outgoing wavelength multiplex, and a post-amplifier in which the outgoing wavelength multiplex is amplified once more.

All components inserted on the path of the information channels through the amplifier unit require space, cause costs and cause insertion losses, which must be compensated by the amplifiers. The larger these losses are, the more powerful and, hence, more expensive the amplifiers must be.

The object of the present invention is to provide a wavelength-selective optical signal processing device having an outcoupling filter for decomposing a wavelength multiplex comprising several channels at different wavelengths into a first and a second group of channels, a processing unit for carrying out a processing of the first group, and an incoupling filter for combining the processed first group and the second group into an outgoing wavelength multiplex, which is compact, simple and economic in realization.

The object is achieved by the outcoupling filter and the incoupling filter having a continous wavelength-selective reflecting structure in common, which reflects the first group from the incoming multiplex into a first direction and transmits the second group, and which reflects the first group arriving from a second direction after passing through the processing unit in the transmission direction of the second group. By merging incoupling and outcoupling filters into this wavelength-selective structure, on the one hand, cost and space requirements are reduced because the structure assumes the tasks of both SCW filters from U.S. Pat. No. 6,411,407; on the other hand, a reduction of insertion losses is achieved in the second group of channels, since these only have to pass through the single wavelength-selective structure instead of two separate filters for coupling in and out.

Preferably, the wavelength-selective reflecting structure is a Bragg grating. Such a Bragg grating may be three-, two-, or one-dimensional; an appropriate one-dimensional grating in form of two partially fused optical fibres is described in U.S. Pat. No. 6,578,388 B1.

Alternatively, a dichroic mirror may be considered as a reflecting structure.

Preferably, the signal processing device of the invention is provided for a wavelength multiplex having a plurality of information channels and at least one supervisory channel, wherein the at least one supervisory channel forms the first group and the information channels form the second group.

If the signal processing device comprises an optical amplifier stage through which the complete wavelength multiplex passes, the amplifier stage and the wavelength(s) of the first group, respectively, are preferably selected such that the optical amplifier stage is transparent for the first group also in its unpumped state, so that it will be transmitted also in case of a failure of the amplifier.

Further features and embodiments of the invention become apparent from the subsequent description of exemplary embodiments thereof, referring to the appended Figures.

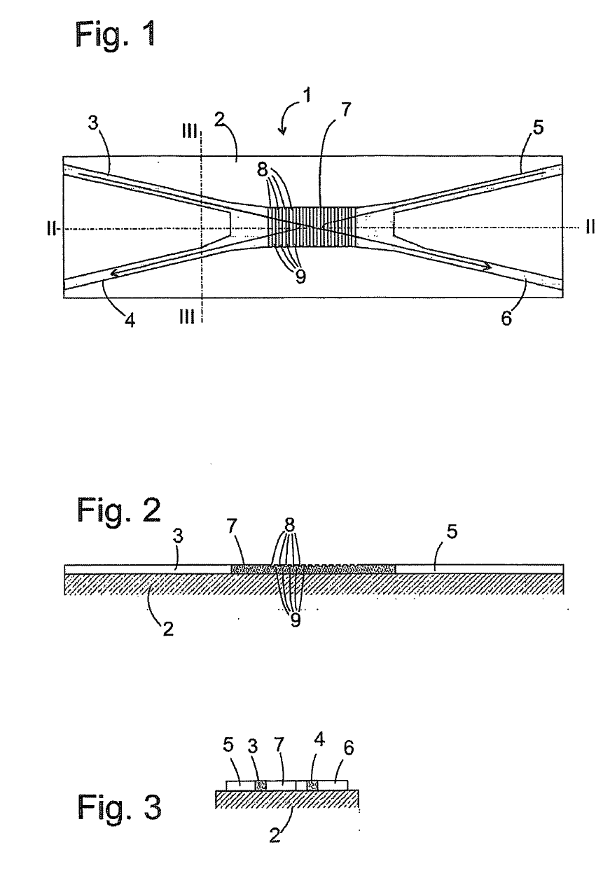

FIG. 1 is a plan view of a combined incoupling/outcoupling filter according to the present invention;

FIG. 2 is a section along line II-II from FIG. 1 according to a first embodiment of the filter;

FIG. 3 is a section along line III-III of FIG. 1 according to a first embodiment of the filter;

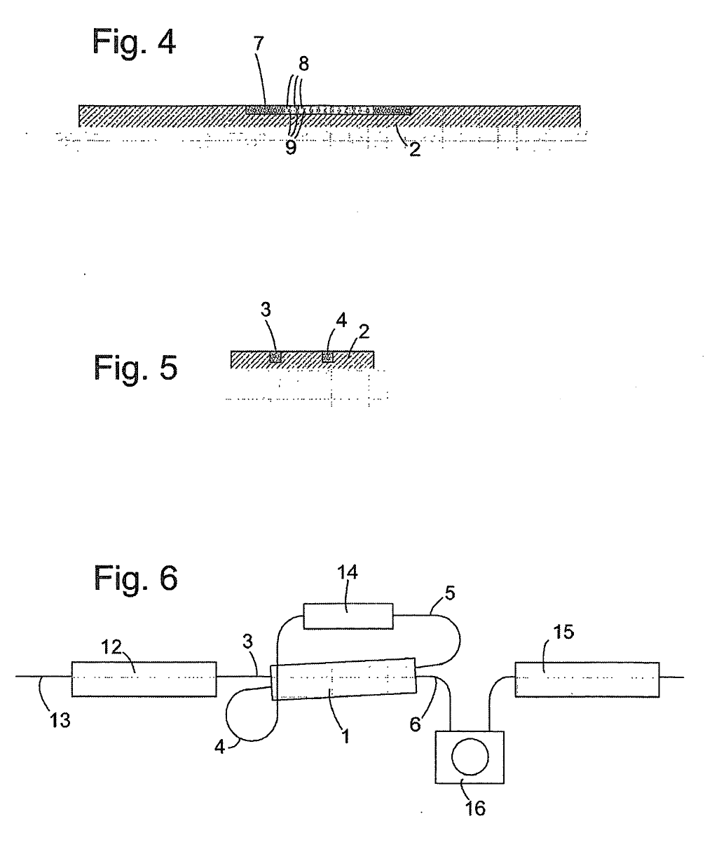

FIG. 4 a section along line II-II from FIG. 1 according to a second embodiment of the filter;

FIG. 5 is a section along line III-III of FIG. 1 according to a second embodiment of the filter;

FIG. 6 is a block diagram of an amplifier unit for long distance transmission of optical signals according to the invention.

FIG. 1 is a plan view of a combined incoupling/outcoupling filter 1 according to an integrated optical embodiment of the invention. On a substrate 2 having an index of refraction n2, four single-mode waveguide sections 3, 4, 5, 6 and, in an intersection region of these waveguides, a Bragg grating zone 7 are formed. The Bragg grating zone 7 comprises a plurality of parallel strips 8, 9 having alternating light propagation characteristics such as index of refraction or thickness.

Among the spectral components of a polychromatic wave which enters the Bragg grating zone 7 e.g. by the waveguide 3, all those components that do not comply with the Bragg reflection condition are transmitted and leave the filter 1 via waveguide 6, which is a straight continuation of waveguide 3 at the other side of Bragg grating zone 7. Spectral components that comply with the Bragg condition are reflected into the waveguide 4. Since reflection occurs in a locally distributed manner at the strips 8, 9, the wave reflected into waveguide 4 may be widened in cross section; a gradually tapered zone 11 in the transition region between the Bragg grating zone and the waveguide 4 is provided for adiabatically adapting the cross section of the reflected wave to that of the waveguide 4.

The arrangement of the waveguides 5, 6 is mirror symmetric with respect to that of waveguides 3, 4; a wave introduced via waveguide 5, which complies with the Bragg condition, is reflected into waveguide 6 and is superimposed there with those spectral components of the wave introduced via waveguide 3 that do not comply with the Bragg condition.

There are different possibilities of forming the filter 1, two of which are briefly illustrated based on the sections of FIGS. 2, 3, and 4, 5, respectively. FIGS. 2 and 3 show the waveguides 3, 4, 5, 6 in the Bragg grating zone 7 to lie on the substrate 2. Such a structure may e.g. be obtained by depositing a thin layer having an index of refraction n1≧n2 on the substrate 2 and subsequently removing this layer by etching everywhere except at the locations of the waveguides 3 to 6 and the Bragg grating zone 7. The Bragg grating is formed by partially etching away the layer in the region of the strips 8, so that the Bragg grating is formed by the strips 8, 9 of alternating thickness.

Alternatively, the filter structure may be formed by diffusing an impurity into the surface of the substrate 2, whereby in the region of the waveguide 3 to 6 and the Bragg grating zone 7, the index of refraction at the surface of the substrate 2 is increased. The sections shown in FIGS. 4 and 5 result. The strips 8, 9 do not differ in thickness here, but in the concentration of the diffused impurities and, hence, in their index of refraction.

FIG. 6 is a block diagram of an amplifier unit for post-amplifying a wavelength multiplex information signal for long distance information transmission on an optical fibre. The input of the amplifier unit is directly formed by an erbium-doped fibre amplifier (EDFA) 12, which amplifies uniformly all information channels of a signal multiplex transmitted on the incoming fibre 13. The wavelength of the supervisory channel is chosen so far away from the maximum gain wavelength of the EDFA 12, that the supervisory channel does not only experience no gain when passing through the EDFA 12, but is not substantially absorbed even if due to a technical failure the EDFA 12 is not pumped and is therefore not capable of amplifying the information signals but absorbs them instead. E.g. while in an EDFA usually the wavelength region from 1530 to 1560 nm is used for the information channels, the supervisory channel is set in a wavelength region between 1600 and 1630 nm. Thus, it is ensured that it will pass through the EDFA 12 even if the information channels are absorbed completely therein.

At an output of EDFA 12, the waveguide 3 of an incoupling/outcoupling filter 1 of the type shown in FIG. 1 is connected. The width of the strips 8, 9 is selected such that the supervisory channel complies with the Bragg condition and is reflected into the fibre 4 and thus reaches a processing unit 14. This processing unit 14 may be an optical amplifier that amplifies the supervisory channel to the same extent to which the EDFA pre-amplifier 12 and an EDFA post-amplifier 15, taken together, amplify the information channels, or a series connection of an optic-electric converter, an electronic regenerator circuit and an electric-optic converter.

After passing through the processing unit 14, the supervisory channel reaches the incoupling/outcoupling filter 1 via its fibre 5, is once more Bragg-reflected therein and is thus spatially superimposed onto the information channels that go through the filter 1 without modification.

The output fibre 6 leads to a dispersion compensator for compensating deformations of the impulses of the information channels caused by dispersion in the fibre 13. Usually, this dispersion compensator 16 is not capable of also compensating correctly the supervisory channel; however, if this is the case, it is no serious problem since usually the supervisory channel has a much lower data rate than the information channels and may therefore operate with much longer impulses in which deformations caused by dispersion are not substantially noticeable.

After the dispersion compensator 16, the wavelength multiplex goes through the EDFA post-amplifier 15 before being output onto an output fibre. Compared to a conventional amplifier unit having separate incoupling and outcoupling filters for the supervisory channel, the information channels of the amplifier unit of the invention go through one optical component less. This does not only lead to a reduction of cost due to the omission of a component but also a reduction of insertion losses by those which are involved with this component and which usually amount to approx. 0.5 to 1 dB. Therefore, a lower performance of the amplifier stages 12, 15 is sufficient in order to obtain a desired total gain of the amplifier unit. While e.g. with a conventional EDFA having 15 meters of fibre length, a pump power of 200 mW is required in order to achieve a gain of 16 dB at 1550 nm, 160 mW are sufficient already for a gain of 15.5 dB. Accordingly, the required amount of pump power is reduced by 20% by the configuration of the invention. Therefore, laser diodes having a substantially reduced performance may be used for pumping the EDFAs of the amplifier unit of the invention, whereby the cost of the amplifier unit is reduced further.

1-7. (canceled)

8. A wavelength-selective optical signal processing device, comprising: an outcoupling filter for decomposing and incoming wavelength multiplex having a plurality of channels at different wavelengths into a first and a second group of channels; a processing unit for carrying out a processing of the first group to obtain a processed first group, and an incoupling filter for combining the processed first group and the second group into an outgoing wavelength multiplex; the outcoupling filter and the incoupling filter having a common continuous wavelength-selective reflecting structure operative for reflecting the first group from the incoming wavelength multiplex into a first direction and letting the second group pass in a passing direction, and also operative for reflecting the first group arriving from a second direction after having passed through the processing unit into the passing direction of the second group.

9. The signal processing device of claim 8, characterized in that the wavelength-selective reflecting structure is a Bragg grating.

10. The signal processing device of claim 8, characterized in that the wavelength-selective reflecting structure is a dichroic mirror.

11. The signal processing device of claim 8, characterized in that the channels include a plurality of information channels and at least one supervisory channel, and in that the at least one supervisory channel forms the first group, and in that the information channels form the second group.

12. The signal processing device of claim 8, and at least one optical amplifier stage passed through by the entire incoming wavelength multiplex.

13. The signal processing device of claim 12, characterized in that the at least one optical amplifier stage is transparent for the first group in an unpumped state.

14. The signal processing device of claim 8, characterized in that the device is a regenerating amplifier for an optical long distance cable.
